(19) United States
(12) Patent Application Publication
(10) Pub. No.: US 2006/0056586 A1
(43) Pub. Date: Mar. 16, 2006

(54) Method and equipment for detecting explosives, etc.

(76) Inventors: Naohito Uetake, Hitachinaka (JP); Young-kun Lee, Hachioji (JP); Shigehisa Tanaka, Kokubunji (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/206,770

(22) Filed: Aug. 19, 2005

(30) Foreign Application Priority Data
Sep. 15, 2004 (JP) 2004-268174

(51) Int. Cl. G01N 23/04

(52) U.S. Cl. 378/57

(57) ABSTRACT

A method and equipment for detecting an explosive, etc. are disclosed. A specified portion highly likely to contain an explosive, etc. is extracted based on the X-ray image obtained by radiating an X ray on an object to be inspected. An electromagnetic wave containing the terahertz wave is radiated on the specified portion thus extracted. The presence or absence of the explosive, etc. is determined based on at least one of the absorption spectrum and the reflection spectrum of the electromagnetic wave at the specified portion.

### BACKGROUND OF THE INVENTION

This invention relates to a method and an equipment for detecting dangerous objects such as explosives and illegal objects such as drugs (hereinafter referred to as the explosives, etc. or the explosive, etc., as required).

The luggage inspection at airports, etc. is conducted primarily to detect dangerous objects such as explosives, guns and knives and contraband goods such as narcotics. This inspection is conducted not only at airports but also at event halls, post offices and cargo terminals frequented by people. Such an inspection is intended for not only dangerous objects such as explosives or guns but also contraband goods and substances including drugs and toxic microorganisms such as anthrax.

The X-ray DR is widely used as a detector of metals such as guns and knives. Specifically, the X-ray DR is for specifying an object in a luggage based on the density and the morphologic features of the object and can detect guns and knives with comparative ease by forming an image of the transmittance distribution of the X ray transmitted through the luggage. For example, the density of a substance is detected from the X-ray transmissibility and explosives, guns and knives are identified and displayed in colors based on density difference. Also, the X-ray CT (computer tomography) technique can produce an internal three-dimensional image.

In the baggage inspection at airports, however, dangerous objects such as explosives as well as guns and knives are desirably detected, and the inspection at the custom house is expected to detect contraband goods such as narcotics. The explosives and drugs (hereinafter referred to as the explosives, etc. or the explosive, etc.) assume an unspecified form and have no significant density difference. It is therefore difficult to find them from a transparent image of X ray.

In view of this, various techniques are proposed for identifying a substance such as an explosive by detecting the chemical composition. In an X-ray device, for example, an attempt has been made to identify a substance by radiating a plurality of X rays of different energy levels and calculating the density and the effective atomic number. The density and the effective atomic number alone, however, fail to provide sufficient information to identify a substance and the result is low in reliability. In another approach, a substance is identified by utilizing the correlation which exists between the absorption spectrum of light such as visible light and a substance. The visible light, however, has a low transmissibility through a substance and can produce the information only on the surface of the substance, and though applicable to a thin article such as mail, is not suitable for luggage having some thickness.

The terahertz wave intermediate between radio wave and light, on the other hand, has a high transmissibility and is known to have an absorption spectrum unique to drugs. An application of the terahertz wave to the inspection for a drug in a thin object like a letter, for example, has been suggested by JP-A-2005-114413 and K. Kawase, Y. Ogawa, Y. Watanabe and H. Inoue, “Non-destructive terahertz imaging of illicit drugs using spectral fingerprints”, Optics Express, Vol. 11, No. 20, pp. 2549-2554 (2003).

In the luggage check at airports or event halls, explosives, etc. are desirably detected in a very short time (several seconds required for the luggage to pass through the inspection gate) without opening the luggage. The mail inspection, on the other hand, involves a very large volume of mail and therefore is required to be improved in throughput.

In the conventional technique of detecting explosives, etc. using the terahertz wave, however, reduction in inspection time is not considered. Measurement of the absorption spectrum by radiating the terahertz wave requires a considerable time as the whole luggage is required to be scanned by the terahertz wave. An attempt to shorten the inspection time by increasing the scanning rate, on the other hand, requires a high-intensity light source. Under the circumstances, however, a light source of high-intensity terahertz wave is still unavailable. Therefore, the measurement of the absorption spectrum and the scanning of a large area consume a very long time and is not suitable for ordinary luggage check.

### SUMMARY OF THE INVENTION

The object of this invention is to provide a method and equipment for detecting explosives, etc., in which explosives, etc. in an object to be inspected can be identified within a short inspection time.

In order to achieve the object described above, according to this invention, the high X-ray transmissibility is organically combined with the high performance of the terahertz wave in identifying explosives, etc. thereby to considerably shorten the detection time of explosives, etc.

Specifically, based on an X-ray image obtained by radiating the X ray on an object to be inspected, a specified portion highly likely to contain an explosive, etc. is extracted. The specified portion thus extracted is irradiated with an electromagnetic wave containing the terahertz wave, and based on at least one of the absorption spectrum and the reflection spectrum of the electromagnetic wave at the specified portion, the presence or absence of an explosive, etc. is determined.

In this way, a specified portion highly likely to contain an explosive, etc. is extracted by a density distribution image, for example, using the high transmissibility of X ray, and therefore the scanning area of the terahertz wave can be narrowed. Thus, the whole measurement time is considerably reduced. An explosive, etc. required to be detected has a certain degree of size. In short, therefore, the measurement can be sufficiently conducted by radiating the terahertz wave at a single point of the specified portion, and therefore an explosive, etc. can be detected within a very short time. As a result, the presence or absence of an explosive, etc. in a luggage can be determined without opening it while the luggage passes on the luggage inspection table.

In this case, the electromagnetic wave containing the terahertz wave is selected in the range of 0.1 to 10 THz or preferably 0.5 to 3 THz. The explosive, etc. is defined to include at least one of an explosive, an illegal drug and a toxic microorganism such as anthrax.

The specified portion highly likely to contain an explosive, etc. can be extracted and set by the operator based on an X-ray image through an input means. As an alternative, the specified portion can be determined automatically by determining whether at least one of the density distribution of the X-ray transmissibility determined based on an X-ray image and the effective atomic number is within a set range or not.

An explosive detection equipment according to the invention comprises an X-ray unit for radiating the X ray on an object to be inspected and generating an X-ray transmitted image based on the X ray transmitted through the object, an electromagnetic wave radiator for radiating the electromagnetic wave containing the terahertz wave on a specified portion highly likely to contain an explosive, etc. based on the transmitted image, and a determining unit for measuring at least one of the absorption spectrum and the reflection spectrum of the electromagnetic wave at the specified portion and determining the presence or absence of an explosive, etc. based on a spectrum unique to the explosive, etc. registered in advance.

Also, according to this invention, the type of an explosive, etc. can be identified based on the transmitted images of a plurality of terahertz waves having different frequencies instead of the absorption or reflection spectrum of the terahertz wave.

Specifically, a specified portion highly likely to contain an explosive, etc. is extracted based on an X-ray image obtained by radiating the X ray on an object to be inspected. An electromagnetic wave containing terahertz waves of two or more different frequencies corresponding to a specified explosive, etc. registered in advance is radiated on the extracted specified portion. The terahertz wave image in at least one of the absorbed electromagnetic wave image and the reflected electromagnetic wave image of the specified portion is acquired for each of the two or more frequencies. The size of an area is determined where the absorption rates of the terahertz waves of the terahertz wave images of the respective frequencies are high and coincident with each other, and in the case where the area size thus determined is larger than a reference value, the presence of the specified explosive, etc. is determined.

According to this invention, an explosive, etc. in an object to be inspected can be identified within a shorter inspection time.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing a general configuration of an explosive detection equipment used for luggage inspection according to an embodiment of the invention.

FIG. 2 is a diagram showing an example of an X-ray transmitted image according to the embodiment shown in FIG. 1.

FIG. 3 is a diagram showing the manner in which the luggage is inspected by the terahertz wave according to the embodiment shown in FIG. 1.

FIG. 4 is a diagram showing an example of the spectral distribution obtained in the embodiment of FIG. 1.

FIG. 5 shows a general configuration of an explosive detection equipment used for mail inspection according to an embodiment of the invention.

FIG. 6 is a diagram showing the manner in which the mail is inspected by the terahertz wave according to the embodiment shown in FIG. 5.

FIG. 7 is a diagram showing an example of an X-ray transmitted image according to the embodiment shown in FIG. 5.

FIG. 8 is a diagram for explaining the steps of identifying a drug according to the embodiment shown in FIG. 5.

FIG. 9 is a general configuration of an explosive detection equipment used for inspection of a container according to an embodiment of the invention.

### DESCRIPTION OF THE INVENTION

Embodiments of the invention are described below.

### Embodiment 1

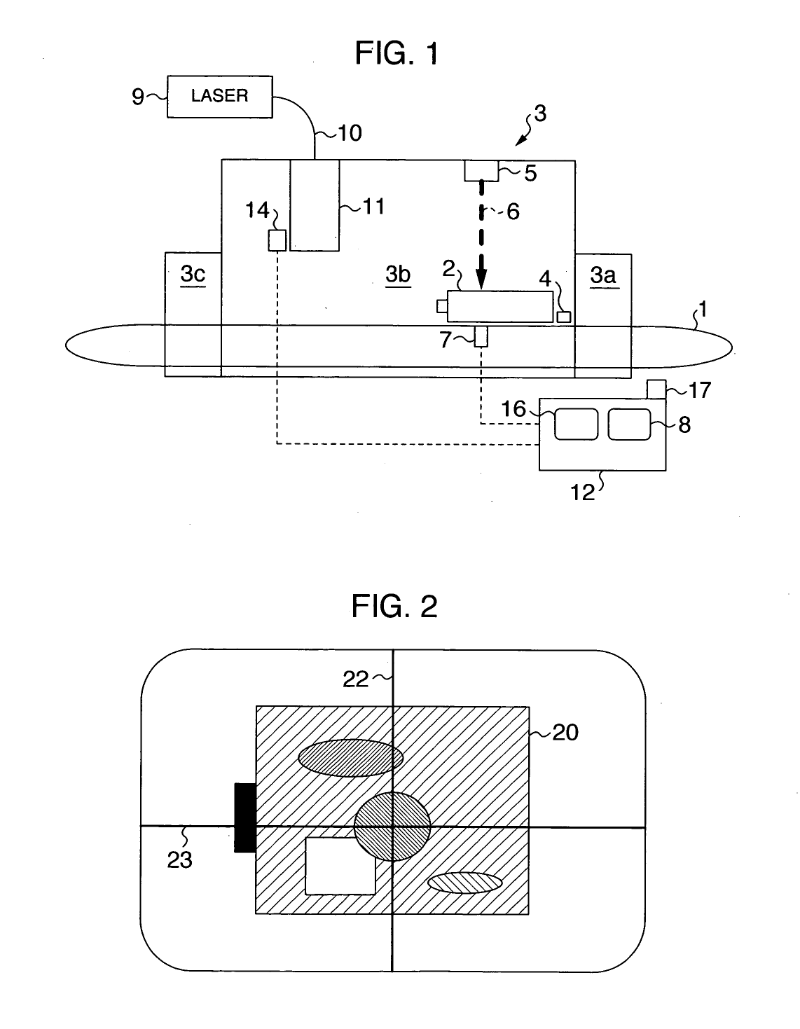

FIG. 1 is a schematic diagram showing a general configuration of an explosive detection equipment using an explosive detection method according to an embodiment of the invention. This embodiment represents an example of application of the invention to the luggage inspection. As shown in FIG. 1, a luggage 2 constituting an object to be inspected is placed on a carriage 1 including a belt conveyor and the like, and transported into the interior 3b from the inlet 3a of an X-ray shield case 3. A band-shaped X-ray shield member formed of a soft material such as rubber is arranged under the passage of the luggage 2 at the inlet 3a, the boundary between the inlet 3a and the interior 3b, the boundary between the interior 3b and the outlet 3c, and the outlet 3c. An optical sensor 4 is arranged at the entrance of the interior 3b of the X-ray shield case 3. An X-ray generator 5 is mounted at the top of the X-ray shield case 3. A planar X-ray beam 6 formed by a collimator not shown is radiated toward the luggage 2. The X ray that has passed through the luggage 2 is detected by a line sensor 7, and input as an image data to an arithmetic unit 12 including an image generating means. The X-ray transmitted image formed by the arithmetic unit 12 is displayed on a screen 8. As a result, the X-ray transmitted image scanned on the luggage 2 moving on the carriage 1 is displayed on the screen 8.

A terahertz wave radiator for radiating the terahertz wave toward the luggage 2 is arranged downstream of the X-ray generator 5 on the carriage 1. The terahertz wave radiator is configured of a femt-sec laser light source 9, an optical fiber 10 and a terahertz light source 11. Specifically, the femt-sec laser beam generated by the femt-sec laser light source 9 is radiated on an optical switch in the terahertz light source 11 through the optical fiber 10. A wide-band electromagnetic wave containing the terahertz wave of 0.5 to 3 THz is released from the optical switch according to the principle of time domain spectroscopy. Also, though not shown, a concave mirror or a lens is arranged in the terahertz light source 11 to converge the terahertz wave released from the optical switch at a specified portion of the luggage 2.

Also, a terahertz wave sensor 14 for receiving the terahertz wave reflected from the luggage 2 is arranged in proximity to the terahertz light source 11. The terahertz wave sensor 14 is constituted of a well-known semiconductor optical switch or pyroelectric sensor to detect and disperse the reflected terahertz wave. The spectral data thus obtained is input to an arithmetic unit 12 including a spectrum measuring means. The arithmetic unit 12 includes a determining means for determining the presence or absence of an explosive, etc. based on the measured spectrum and a spectrum unique to the explosive, etc. in registration. The result of this determination is notified by being displayed on the screen 16. The measured spectrum is also displayed on the screen 16 whenever required.

Specifically, the explosive detection equipment according to this embodiment comprises the X-ray generator 5 providing an X-ray radiation means for radiating the X ray on the luggage 2 to be inspected, the line sensor 7 providing an X-ray detection means for detecting the X ray transmitted through the luggage 2 and the arithmetic unit 12 providing an image generating means for generating the X-ray transmitted image based on the detection signal of the X ray detected by the line sensor 7. Also, a specified portion setting means for setting a specified portion highly likely to contain an explosive, etc. based on the X-ray transmitted image includes an input means such as a cursor or a touch panel for setting the specified portion on the X-ray transmitted image displayed on the screen 8.

In order to identify the type of the explosive, etc., on the other hand, the explosive detection equipment according to this embodiment comprises the terahertz light source 11 providing an electromagnetic wave radiation means for radiating the electromagnetic wave containing the terahertz wave on a specified portion, the terahertz wave sensor 14 providing an electromagnetic wave detector for detecting the electromagnetic wave reflected from the specified portion, the spectrum measurement means for measuring the spectrum of the reflected wave and the arithmetic unit 12 providing a determining means for determining the presence or absence of an explosive, etc. based on the measured spectrum and a spectrum unique to the explosive, etc. registered in advance.

With reference to the embodiment having this configuration, the operation of detecting an explosive, etc. is explained. The luggage 2 transported on the carriage 1 enters the interior 3b from the inlet 3a of the X-ray shield case 3. The luggage 2 is detected the optical sensor 4, and an X ray beam 6 is radiated at the timing of the luggage 2 reaching the position of the X-ray generator 5. The X ray that has been transmitted through the luggage 2 is detected by the line sensor 7, and the image data corresponding to the X ray transmissibility is input to the arithmetic unit 12. The arithmetic unit 12 generates an X-ray transmitted image based on the input image data and displays it on the screen 8. The luggage 2 on the carriage 1 is moved through the position just under the X-ray beam 6. Thus, the X-ray transmitted image shown in FIG. 2 is displayed on the screen 8.

As shown in FIG. 2, for example, each portion of a high X-ray transmissibility is displayed in black, and each portion of a low X-ray transmissibility in white. The feature of the gradation of the X-ray transmitted image corresponds to the density and thickness of the articles contained in the luggage 2. An area 21 estimated to have a density near to that of an explosive, for example, can be displayed in a specified color (red, for example). The operator observing the X-ray transmitted image sets the crossing point of the vertical cursor 22 and the horizontal cursor 23 at a doubtful portion and thus sets a position (specified portion) desirably to be checked in detail. The cursor may be an arrow to indicate a given position in the screen or a touch panel may be used to set a specified portion.

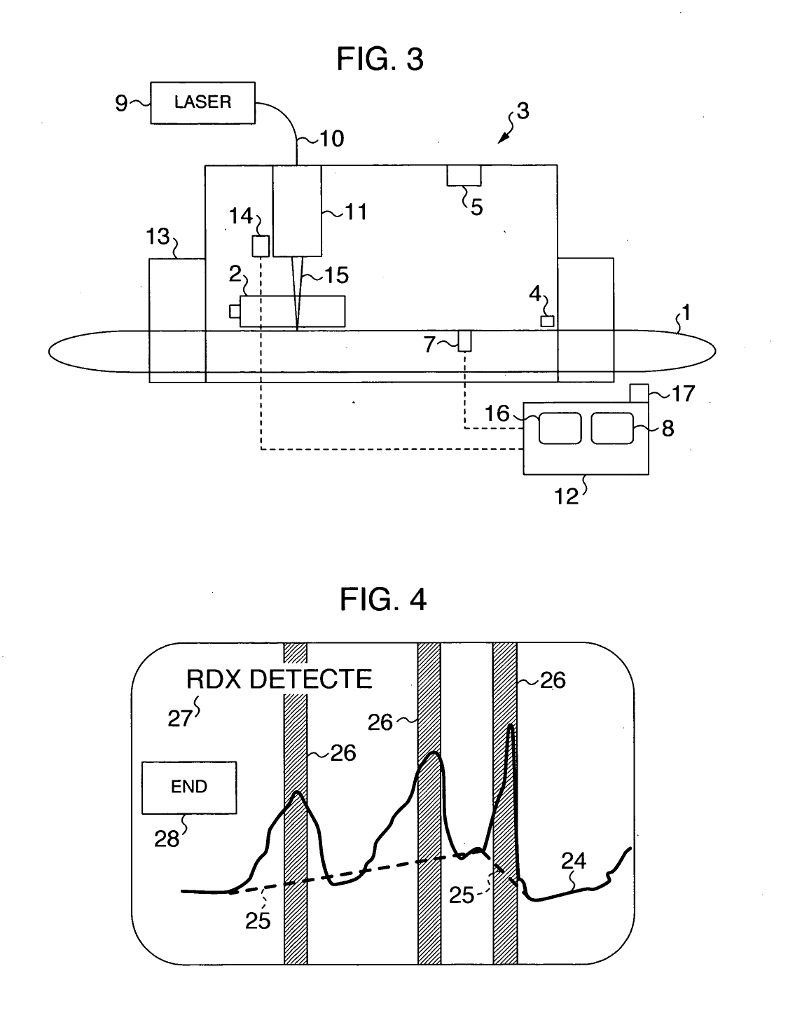

Once the specified portion is set by the operator, the arithmetic unit 12, as shown in FIG. 3, stops the carriage 1 at such a timing that the specified portion of the luggage 2 is located just under the terahertz light source 11. In the case where the specified portion is not set within a predetermined time, the carriage 1 is not stopped and the luggage is delivered from the outlet 3c. When the specified portion of the luggage 2 is transported to a position just under the terahertz light source 11, the laser beam from the femt-sec laser light source 9 is radiated on the optical switch arranged in the terahertz light source 11, and the wide-band electromagnetic wave 15 containing the terahertz wave of 0.5 to 3 THz from the optical switch is radiated in such a manner as to be focused on the specified portion thus set. The terahertz wave reflected from the specified portion is received by the terahertz wave sensor 14 and after being dispersed, input to the arithmetic unit 12. The arithmetic unit 12 determines the spectral distribution of the terahertz wave using the input spectral data and displays it on the screen 16. FIG. 4 shows an example of the spectral distribution displayed on the screen 16. In FIG. 4, the abscissa represents the frequency (THz) and the ordinate the signal intensity.

The relation between an explosive, etc. and the reflection spectrum unique to the terahertz wave is explained. First, an explosive and a drug are known to exhibit a spectrum unique to the composition thereof against the terahertz wave of 0.5 to 3 THz. The millimeter wave with the frequency lower than 0.1 THz, however, exhibits no spectrum having a significant feature in spite of its high transmissibility. The infrared ray area with a frequency higher than 10 THz, on the other hand, has a spectrum of a significant feature but low in transmissibility. Since many substances have a spectrum of a significant feature, it may be difficult to identify a specified substance. For example, RDX which is a main chemical component of the plastic bomb C4 exhibits a spectrum of a significant feature having a peak at about 0.75 THz, 1.4 THz and 1.9 THz. Many substances including wood, paper, cloth and leather used for cases and bags such as luggage exhibit no spectrum of a significant feature against the terahertz wave. Explosives and illegal drugs, on the other hand, normally exhibit a spectrum of a significant feature in two or more areas against the terahertz wave of 0.5 to 3 THz, and therefore the type of an explosive or an illegal drug can be identified.

Further, the logic to identify the type of explosives and illegal drugs can be formed by combining a plurality of features on the spectrum. By doing so, in the case where a given substance happens to have a spectrum in the same area as another substance, an identification error can be considerably reduced by combining a plurality of features. Also, even in the absence of a spectrum having a significant feature, the base line 25 of the spectrum 24 shown in FIG. 4 is affected. It is therefore desirable to determine and subtract the base line 25 by arithmetic operation from the spectrum 24 obtained. Further, in the case where there are a plurality of peaks having a significant feature of the spectrum 24, an area 26 of a predetermined width is set in the neighborhood of each peak position, and the spectrum 24 within the particular area 26 is integrated. Thus, on condition that the integrated value at the peak of each area 26 exceeds a registered reference value corresponding to each of various explosives (registered objects to be detected), a specified explosive, etc. can be identified.

Once a doubtful object in the luggage 2 is found to be an explosive, etc., as shown in FIG. 4, an alarm 27 of RDX detection, for example, is displayed on the screen 16, while at the same time lighting an alarm 17 with an alarm sound. Also, in the case where the integrated value of the area 26 satisfies the reference value of any one of the registered objects to be detected, the names of all the corresponding objects to be detected are displayed on the screen 16.

In the case where the integrated value fails to satisfy any one of the reference values of the registered objects to be detected, on the other hand, the wording “not detected” is displayed. In this case, the operator can change the place of the specified portion and by setting the cursor, can inspect another doubtful portion with a similar operation. At the end of the detecting operation, an end command 28 on the screen 16 is selected. Then, the carriage 1 begins to move again and the luggage 2 having been inspected is delivered out from the outlet 3c, and the next luggage 2 is ready for inspection.

As explained above, according to this embodiment, utilizing the high transmissibility of the X ray, a specified portion highly likely to contain an explosive, etc. is extracted by a density distribution image, for example, and an inspection for identifying an explosive, etc. is conducted with the terahertz wave in the extracted narrow area. Thus, the total inspection time can be considerably reduced. An explosive, etc. required to be searched has some degree of size, and therefore, in short, measurement is possible by radiating the terahertz wave at a single point of the specified portion. Also, only a very small area is scanned, if required, and therefore an explosive, etc. can be detected within a short time. As a result, the presence or absence of an explosive, etc. in the luggage can be determined without opening the luggage while being transported on the carriage 11 like the inspection table.

The embodiment is explained above with reference to a case in which the electromagnetic wave containing the terahertz wave has a wide frequency band of 0.5 to 3 THz. Nevertheless, the invention is not limited to the frequency range, and a wide-band electromagnetic wave of 0.1 to 10 THz can be selected. Also, although RDX is taken up as an example of the explosive, etc., the invention is not limited to RDX and various explosives, illegal drugs and toxic microorganisms such as anthrax can be detected. Of course, the features of the terahertz wave spectrum of the object to be detected are required to be analyzed and the reference values for identification are required to be registered beforehand in the arithmetic unit 12.

Also, according to this embodiment, the explanation has been made about a case in which the operator sets a specified portion highly likely to contain an explosive, etc. on the screen 8 through the input means. The invention is not limited to such a case, but the specified portion can be set automatically. For example, upon determination that at least one of the density distribution of the X-ray transmitted image and the effective atomic number is included in a set range as a reference value, a specified portion can be set automatically.

Also, instead of using the reflection spectrum based on the wave reflected from a specified portion of the luggage as in the embodiment described above, an explosive, etc. can be identified and detected with equal effect by use of the absorption spectrum absorbed into a specified portion. The absorption spectrum has an inverted waveform of the spectrum 24 shown in FIG. 4.

### Embodiments 2

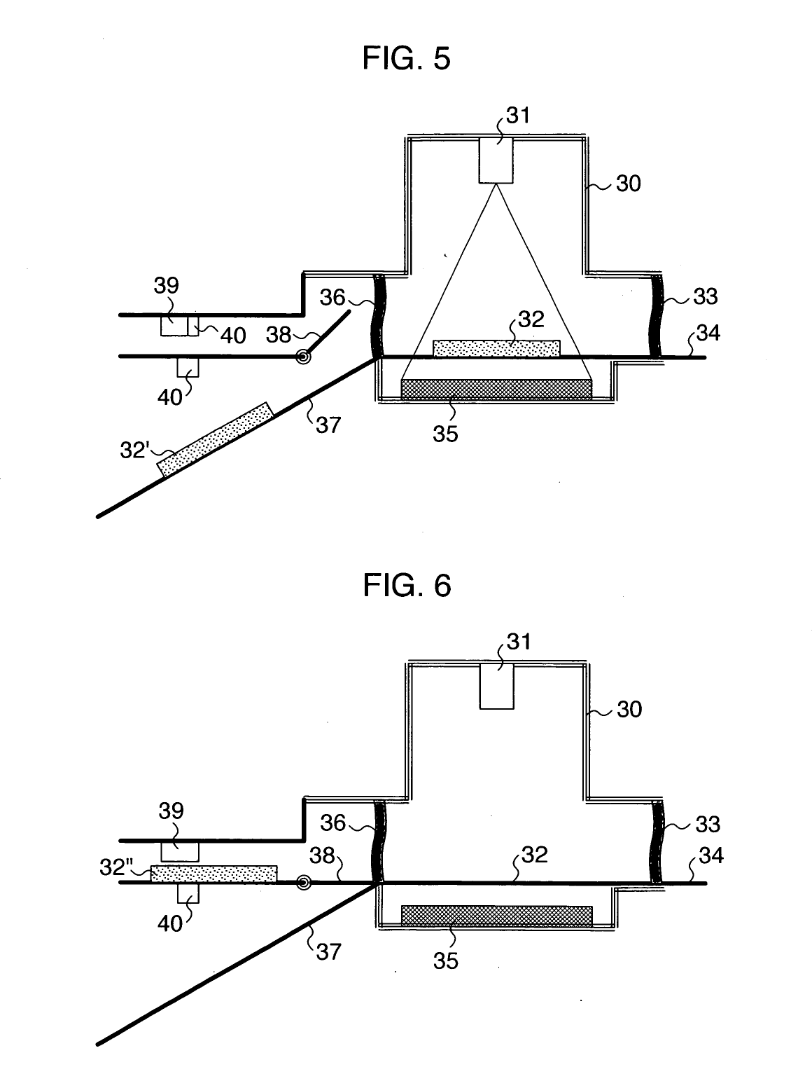

FIG. 5 is a diagram showing a general configuration of a detection equipment using a method of detecting explosives, etc. according to another embodiment of the invention. This embodiment represents a case in which the invention is applied to a comparatively small object such as mail.

As shown in FIG. 5, an X-ray generator 31 is arranged at the top of an X-ray shield case 30. An object 32 is continuously sent by a conveyor 34 through an inlet shield 33 made of a soft material. The X-ray transmitted image of the object 32 to be inspected is displayed as an image using a flat panel 35. In the case where the observation shows no doubtful point, the object is delivered out of the system along a slope 37 through an outlet shield 36 formed of a soft material.

In the case where the operator determines that a doubtful portion exists, on the other hand, a conveyor 38 is activated by button operation, and as shown in FIG. 6, the object 32 is sent to a separate terahertz wave inspection room. In the terahertz wave inspection room, a terahertz wave generator 39 and a terahertz wave receiver 40 are arranged in opposed relation to each other in such position as to hold the object 32 therebetween. Though not shown, also in this embodiment, like in the embodiment shown in FIG. 1, an arithmetic unit 12 having screens 8, 16 is included.

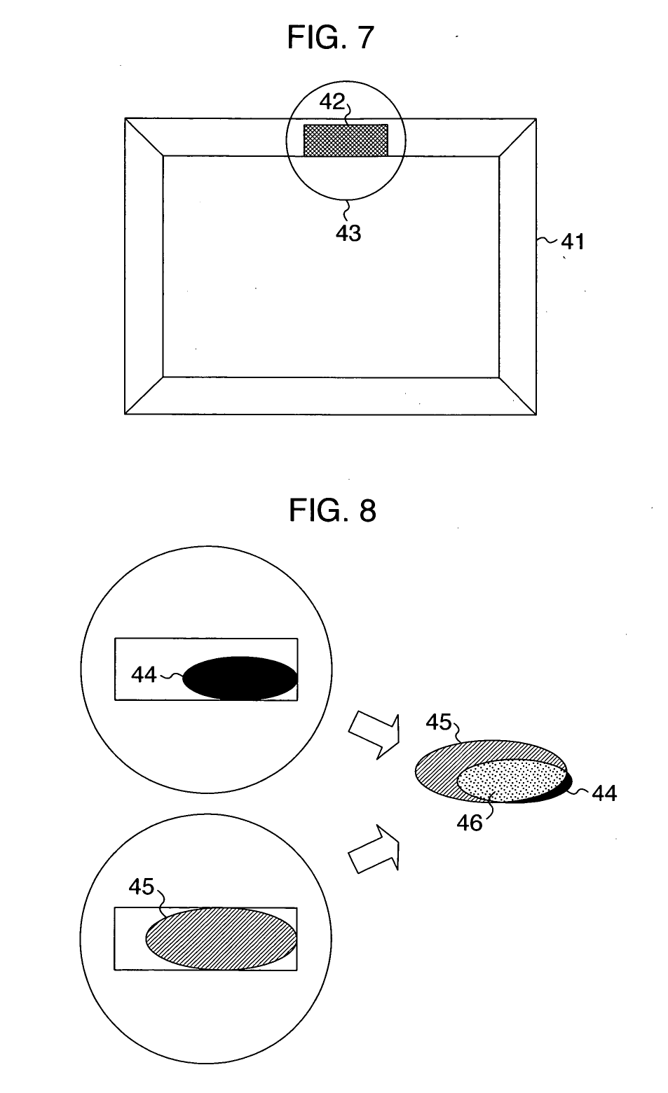

The operation of this embodiment having the configuration described above is explained with reference to FIG. 7. FIG. 7 shows an example of the X-ray transmitted image of the object 32 to be inspected. As shown in FIG. 7, a frame 41 is contained in the mail as an object 32 to be inspected, and a part of the frame 41 makes up a doubtful hollow 42. The operator designates the center of the hollow 42 with cursor. The arithmetic unit 12 controls the terahertz wave generator 39 and the terahertz wave receiver 40 to scan the area 43 around the hollow 42 with the terahertz wave. Thus, a reflection image or an absorption image of the terahertz wave is obtained. FIG. 8 shows an example of the transmitted image (terahertz image) in the area 43. The arithmetic unit 12 has registered therein two or more feature frequencies of the terahertz wave corresponding to a specified drug (specified explosive, etc.) constituting an object to be inspected. The arithmetic unit 12 causes a specified portion to be irradiated with the terahertz wave of two or more specified frequencies registered for a specified drug, and thus acquires the transmitted images thereof. For example, the terahertz wave of two frequencies registered for the same specific drug are radiated in the area 43 of the specified portio and displays the transmitted image as shown in FIG. 8 on the screen 16.

FIG. 8 shows an area 44 which strongly absorbs the terahertz wave of a specified frequency and an area 45 which absorbs a terahertz wave of another specified frequency. The two areas 44 and 45 are superposed one on the other and in the case where the ratio of the coincident area 46 is more than a predetermined reference value, the arithmetic unit 12 determines that the specific portion involves the registered drug. Specifically, the arithmetic unit 12 confirms that the spectra are originated from the same position and excludes external disturbances such as noises. Then, the arithmetic unit 12 displays the corresponding name of the drug on the screen 16, while at the same time sounding an alarm.

The embodiment is explained above taking a transmitted image as an example. It is also possible to use a reflected image or both an absorbed image and a reflected image in combination. Also, as long as bacteria such as anthrax are in powder form, a spectrum having a significant feature is measured and a detection logic is created to make detection possible.

As described above, according to this embodiment, a drug or anthrax contained in mail can be detected reliably without opening the mail.

### Embodiment 3

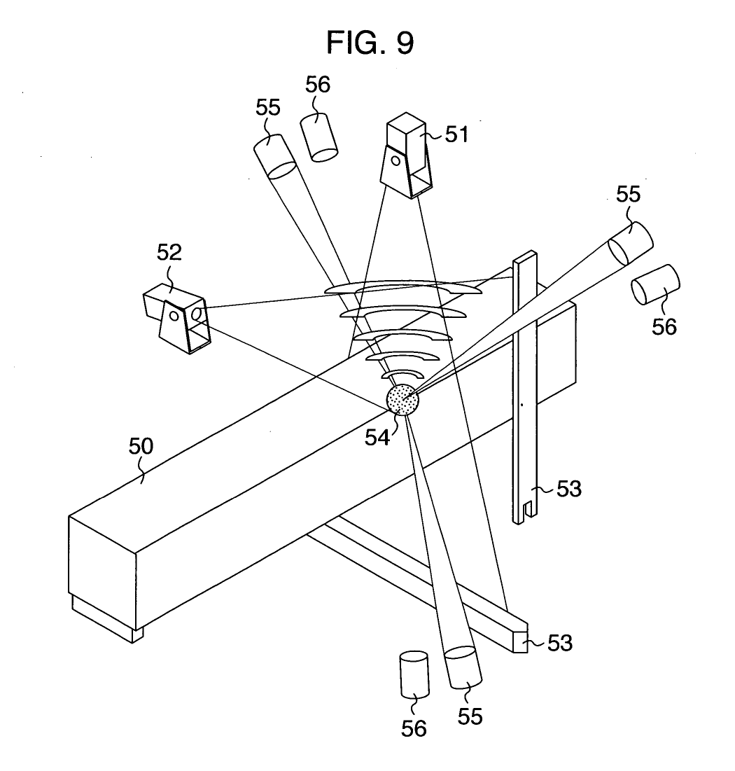

FIG. 9 shows a general configuration of an explosive detection equipment using an explosive detection method according to still another embodiment of the invention. This embodiment represents an application of the invention to automatic detection of an explosive in a container at a cargo terminal, etc.

The X ray can be radiated from two directions from a vertical X-ray radiator 51 and a horizontal X-ray radiator 52. Also, vertical and horizontal X-ray line sensors 53 correspond to the vertical X-ray radiator 51 and the horizontal X-ray radiator 52, respectively. The vertical and horizontal X-ray line sensors 53 are moved together with the vertical X-ray radiator 51 and the horizontal X-ray radiator 52, respectively, and can scan the container 50 from the ends thereof.

Also, the X-ray energy can be switched between high and low levels alternately. The vertical and horizontal X-ray transmitted images are picked up, and from these transmitted images, the density distribution and the effective atomic number are calculated. Based on the density and the effective atomic number thus calculated, an area 54, if found, coincident with the range of density and effective atomic number of the explosive etc. set in advance is set as a specific portion.

Then, the terahertz wave is radiated and focused automatically from terahertz wave radiators 55 at the set area 54 of the specific portion. In this case, the terahertz wave is radiated from at least three points. The reflection spectrum of the terahertz wave is acquired by terahertz wave detectors 56 corresponding to each terahertz wave radiator 55. Like in the embodiment shown in FIG. 1, an arithmetic unit not shown determines whether the data of the reflection spectrum unique to the explosive, etc. registered in advance is coincident with the reflection spectrum of the measurement area 54 in a tolerable range, and in the case where they are so coincident with each other, issues an alarm against the detection of the explosive, etc., while at the same time displaying the location of the area 54 on the image of the container 50 obtained by X ray in vertical and horizontal directions.

A substance resistant to the terahertz wave may exist in the container 50. Therefore, the terahertz wave radiators 55 and the terahertz wave detectors 56 are arranged in such a manner that the detection is possible from at least three directions. The radiation and detection from at least three directions makes the detection possible even in the case where the terahertz wave is blocked by some substance.

Also, by measuring the difference of time from the radiation of the terahertz wave on the area 54 of the specified portion to the return of the reflected terahertz wave, it is possible to determine whether terahertz wave is reflected from the focused area 54 of the specified portion. In the case where the reflected wave returns through a shorter distance than the focused area 54, for example, the presence of an obstacle midway can be estimated. In the case where the result is the same for all the three directions, on the other hand, an alarm is issued indicating that an explosive, etc. may be shielded.

Instead of radiating the X ray from horizontal and vertical directions, each set of the X-ray radiator 51 and the X-ray detector 53 can be configured to rotate around the container 50. Alternatively, the X-ray radiator and the X-ray detector can be fixed while the container 50 is rotated. As a result, an X-ray CT image is obtained, and the presence or absence of the area 54 coincident with the range of the density and the effective atomic number of the explosive, etc. is inspected on the CT image. Thus, the position of the explosive, etc. can be easily determined with a higher reliability.

According to this embodiment, an explosive, etc. in a bulky object can be automatically detected.

It should be further understood by those skilled in the art that although the foregoing description has been made on embodiments of the invention, the invention is not limited thereto and various changes and modifications may be made without departing from the spirit of the invention and the scope of the appended claims.

1. A method of detecting an explosive, etc. comprising the steps of:
extracting a specific portion highly likely to contain the explosive, etc. based on the X-ray image obtained by radiating the X ray on an object to be inspected and;
radiating the electromagnetic wave containing the terahertz wave on the specified portion thus extracted; and
detecting the presence or absence of the explosive, etc. based on at least one of the absorption spectrum and the reflection spectrum of the electromagnetic wave at the specified portion.

2. A method of detecting an explosive, etc. according to claim 1,
wherein the frequency of the electromagnetic wave is in the range of 0.1 to 10 THz or preferably 0.5 to 3 THz.

3. A method of detecting an explosive, etc. according to claim 1,
wherein the explosive, etc. is at least one of an explosive, an illegal drug and a toxic microorganism like anthrax.

4. A method of detecting an explosive, etc. according to claim 1,
wherein the object to be inspected is a luggage transported on a carriage, and
wherein the X ray and the electromagnetic wave are radiated on the luggage transported on the carriage.

5. A method of detecting an explosive, etc. according to claim 1,
wherein the specified portion is extracted by the operator based on the X-ray image and set by an input means.

6. A method of detecting an explosive, etc. according to claim 1,
wherein the specified portion is determined on the basis of the fact that at least one of the density distribution of the X-ray transmissibility and the effective atomic number determined based on the X-ray image is included in a set range.

7. An equipment for detecting an explosive, etc. comprising:
an X-ray unit for radiating the X ray on an object to be inspected and generating an X-ray transmitted image based on the X ray transmitted through the object;
an electromagnetic wave radiator for radiating the electromagnetic wave containing the terahertz wave on a specific portion highly likely to contain the explosive, etc. based on the transmitted image; and
a determining unit for measuring at least one of the absorption spectrum and the reflection spectrum of the electromagnetic wave at the specified portion and determining the presence or absence of the explosive, etc. based on the spectrum unique to the explosive, etc. registered in advance.

8. An equipment for detecting an explosive, etc. comprising:
a carriage for transporting an object to be inspected;
an X-ray unit for radiating the X ray on the object transported on the carriage and generating an X-ray transmitted image based on the X ray transmitted through the object;
an electromagnetic wave radiator arranged downstream of the X-ray unit on the carriage for radiating the electromagnetic wave including the terahertz wave on a specified portion highly likely to contain an explosive, etc. based on the transmitted image;
an electromagnetic wave detector for detecting at least one of the absorbed electromagnetic wave and the reflected electromagnetic wave at the specified portion irradiated with the electromagnetic wave;
a spectrum measuring means for measuring the spectrum of at least one of the absorbed wave and the reflected wave;
a determining means for determining the presence or absence of an explosive, etc. based on the measured spectrum and the spectrum unique to the explosive, etc. registered in advance; and
an announcing means for announcing the result of determination.

9. An equipment for detecting an explosive, etc. according to claim 7,
wherein the specified portion highly likely to contain the explosive, etc. is set in accordance with at least the density difference of the transmitted image.

10. An equipment for detecting an explosive, etc. according to claim 8,
wherein the specified portion highly likely to contain the explosive, etc. is set in accordance with at least the density difference of the transmitted image.

11. An equipment for detecting an explosive, etc. comprising:
an X-ray unit for radiating the X ray on a container to be inspected and generating an X-ray transmitted image based on the X ray transmitted through the container;
an electromagnetic wave radiator for radiating an electromagnetic wave containing the terahertz wave on a specified portion highly likely to contain an explosive, etc. set based on at least the density difference of the X-ray transmitted image;
an electromagnetic wave detector for detecting the electromagnetic wave reflected from the specified portion irradiated with the electromagnetic wave;
a spectrum measuring means for measuring the spectrum of the reflected wave; and
a determining means for determining the presence or absence of the explosive, etc. based on the measured spectrum and the spectrum unique to the explosive, etc. registered in advance.

12. An equipment for detecting an explosive, etc. according to claim 11,
wherein at least three sets of the electromagnetic wave radiator and the electromagnetic wave detector radiate the electromagnetic wave on the specific portion from different directions and detect the reflected waves.

13. A method of detecting an explosive, etc. comprising the steps of:
extracting a specified portion highly likely to contain an explosive, etc. based on an X-ray image obtained by radiating the X ray on an object to be inspected;
irradiating the extracted specified portion with an electromagnetic wave containing the terahertz waves of at least two different frequencies corresponding to a specified explosive, etc. registered in advance;
acquiring the terahertz wave image of at least one of the absorbed electromagnetic wave image and the reflected electromagnetic wave image of the specified portion for each of at least the two frequencies;
determining the size of an area where the range of high terahertz wave absorption rates of the terahertz wave images of the respective frequencies coincide with each other; and
determining the existence of the specified explosive, etc. in the case where the size thus determined is not less than a reference value.

14. An equipment for detecting an explosive, etc. comprising:
a transportation means for transporting an object to be inspected;
an X-ray unit for radiating the X ray on the object transported on the transportation means and generating an X-ray transmitted image based on the X ray transmitted through the object;
a setting means for setting a specified portion highly likely to contain the explosive, etc. based on at least the density difference of the X-ray transmitted image;
an electromagnetic wave radiator for irradiating the specified portion with an electromagnetic wave containing the terahertz waves of at least two different frequencies corresponding to the specified explosive, etc. registered in advance;
an electromagnetic wave detector for detecting at least one of the electromagnetic waves absorbed into and reflected from the specified portion irradiated with the electromagnetic waves;
a terahertz wave image generating means for generating terahertz wave images corresponding to the at least two frequencies based on the detected electromagnetic waves; and
a hazardous substance determining means for determining the size of an area where the range of high terahertz wave absorption rates of the terahertz wave images of the respective frequencies coincide with each other and determining the existence of the specified explosive, etc. in the case where the size is not less than a reference value.
